(19) United States
(12) Patent Application Publication
(10) Pub. No.: US 2015/0258684 A1
(43) Pub. Date: Sep. 17, 2015

(54) ROBOT, ROBOT SYSTEM, AND CONTROL DEVICE

(71) Applicant: Seiko Epson Corporation, Tokyo (JP)

(72) Inventors: Tomoki HARADA, Matsumoto (JP); Shingo KAGAMI, Sendai (JP); Kotaro OMI, Yokohama (JP)

(21) Appl. No.: 14/643,192

(22) Filed: Mar. 10, 2015

(30) Foreign Application Priority Data
Mar. 14, 2014 (JP) 2014-051582

(51) Int. Cl. B25J 9/16

(52) U.S. Cl. CPC B25J 9/1612; B25J 9/1697; B25J 9/1651; Y10S 901/47; G05B 2219/39224

(57) ABSTRACT

A robot includes a hand configured to grip a flexible object and a control section configured to cause the hand to operate. The control section causes the hand to operate using relative velocities of the hand and a predetermined section of the flexible object.

### BACKGROUND

1. Technical Field

The present invention relates to a robot, a robot system, and a control device.

2. Related Art

Researches and developments have been conducted for techniques concerning visual servo for detecting, with a picked-up image picked up by an image pickup section, changes in relative positions of a predetermined position and a target object and using the changes as feedback information to thereby track the target object. A robot employing the visual servo can perform work for, for example, sequentially picking up, with an image pickup section, an image including a work target and a gripping section that grips the work target and moving, with the gripping section, the work target to a target position on the basis of the picked-up image.

In relation to these techniques, there is known a technique for, in a robot control device, making use of an adjusting function of an optical system included in a camera of a robot and incorporating the adjusting function in a feedback system of the visual servo (see JP-A-2003-211382 (Patent Literature 1)).

However, in the robot control device in the past, it is not taken into account that the robot control device causes the robot to grip a sheet-like flexible object such as a label, a sticker, or paper. The flexible object gripped by the robot cannot be moved to a target position in a predetermined position and a predetermined posture of the flexible object.

### SUMMARY

An advantage of some aspects of the invention is to provide a robot, a robot system, and a control device that can perform work suitable for a flexible object.

An aspect of the invention is directed to a robot including: a hand configured to grip a flexible object; and a control section configured to cause the hand to operate. The control section causes the hand to operate using relative velocities of the hand and a predetermined section of the flexible object.

With this configuration, the robot causes the hand to operate using the relative velocities of the hand and the predetermined section of the flexible object. Consequently, the robot can perform work suitable for the flexible object.

In another aspect of the invention, the robot may be configured such that the flexible object is a sheet-like object.

With this configuration, the robot grips the sheet-like object and causes the hand to operate using relative velocities of the hand and a predetermined section of the sheet-like object. Consequently, the robot can perform work suitable for the sheet-like object.

In another aspect of the invention, the robot may be configured such that the predetermined section is the middle point of an end side of the flexible object.

With this configuration, the robot causes the hand to operate using relative velocities of the hand and the middle point of the end side of the flexible object. Consequently, the robot can perform work suitable for the flexible object according to the movement of the end side of the flexible object.

In another aspect of the invention, the robot may be configured such that the robot further includes an image pickup section configured to pickup an image including the flexible object, and the control section calculates the relative velocities on the basis of the picked-up image.

With this configuration, the robot picks up an image including the flexible object and calculates the relative velocities on the basis of the picked-up image. Consequently, the robot can sequentially determine states of the hand and the flexible object to move the hand and perform work suitable for the flexible object.

In another aspect of the invention, the robot may be configured such that the image pickup section includes: a first image pickup section including a first leans and a first image pickup element; and a second image pickup section including a second lens and a second image pickup element, and the image pickup section condenses, with the first lens, light including the flexible object, which is made incident from a first direction, on the image pickup element and condense, with the second lens, light including the flexible object, which is made incident from a second direction, on the second image pickup element.

With this configuration, the robot condenses, with the first lens, the light including the flexible object, which is made incident from the first direction, on the first image pickup element and condenses, with the second lens, the light including the flexible object, which is made incident from the second direction, on the second image pickup element. Consequently, the robot can calculate, on the basis of the first picked-up image picked up by the first image pickup element and the second picked-up image picked up by the second image pickup element, a three-dimensional position and a posture of the flexible object by using epipolar constraint. As a result, the robot can perform work suitable for the flexible object on the basis of the three-dimensional position and the posture of the flexible object.

In another aspect of the invention, the robot may be configured such that the image pickup section includes a plurality of lenses arrayed on a surface parallel to the surface of the image pickup element and having focal points different from one another and pick up an image including information in a depth direction obtained by the plurality of lenses.

With this configuration, the robot picks up an image including information in the depth direction obtained by the plurality of lenses. Consequently, the robot can calculate a three-dimensional position and a posture of the flexible object on the basis of one picked-up image including information in the depth direction without using epipolar constraint based on two picked-up images. Therefore, it is possible to reduce time of calculation processing.

In another aspect of the invention, the robot may be configured such that the control section calculates, on the basis of the picked-up image, an approximation formula representing a surface shape of the flexible object and calculate, on the basis of the calculated approximation formula, a position and a posture of the predetermined section of the flexible object to calculate the relative velocities.

With this configuration, the robot calculates, on the basis of the picked-up image, an approximation formula representing a surface shape of the flexible object and calculates, on the basis of the calculated approximation formula, a position and a posture of the predetermined section of the flexible object. Consequently, the robot can perform work suitable for the flexible object on the basis of changes in the position and the posture of the predetermined section of the flexible object.

In another aspect of the invention, the robot may be configured such that the control section extracts a partial region including the predetermined section of the flexible object in the picked-up image and calculate, on the basis of the extracted partial region, an approximation formula representing a surface shape of the flexible object.

With this configuration, the robot extracts a partial region including the predetermined section of the flexible object in the picked-up image and calculates, on the basis of the extracted partial region, an approximation formula representing a surface shape of the flexible object. Consequently, the robot can reduce time of image processing compared with image processing performed on the basis of the entire picked-up image.

In another aspect of the invention, the robot may be configured such that the control section calculates relative positions of the hand and the flexible object on the basis of the position and the posture of the predetermined section of the flexible object and the position and the posture of a point set in the hand in advance to calculate the relative velocities.

With this configuration, the robot calculates relative positions of the hand and the flexible object on the basis of the position and the posture of the predetermined section of the flexible object and the position and the posture of a point set in the hand in advance to calculate the relative velocities. Consequently, the robot can perform work suitable for the flexible object on the basis of the relative positions of the hand and the flexible object.

In another aspect of the invention, the robot may be configured such that the control section calculates a Jacobian matrix on the basis of the picked-up image and the relative velocities.

With this configuration, the robot calculates a Jacobian matrix on the basis of the picked-up image and the relative velocities. Consequently, the robot can perform work suitable for the flexible object on the basis of the Jacobian matrix.

In another aspect of the invention, the robot may be configured such that the control section moves the hand using visual servo on the basis of the Jacobian matrix.

With this configuration, the robot moves the hand using the visual servo on the basis of the Jacobian matrix. Consequently, the robot can perform work by the visual servo suitable for the flexible object.

Another aspect of the invention is directed to a robot system including: an image pickup section configured to pick up an image including a flexible object; a robot including a hand that grips the flexible object; and a control section configured to cause the hand to operate. The control section causes the hand to operate using relative velocities of the hand and a predetermined section of the flexible object.

With this configuration, the robot system picks up an image including the flexible object, grips the flexible object, and causes the hand to operate using relative velocities of the hand and the predetermined section of the flexible object. Consequently, the robot system can perform work suitable for the flexible object.

Another aspect of the invention is directed to a control device that causes a robot to operate. The robot includes a hand that grips a flexible object. The control device causes the hand to operate using relative velocities of the hand and a predetermined section of the flexible object.

With this configuration, the control device causes the robot, which includes the hand that grips the flexible object, to operate and causes the hand to operate using relative velocities of the hand and the predetermined section of the flexible object. Consequently, the control device can perform work suitable for the flexible object.

As explained above, the robot, the robot system, the control device cause the hand to grip the flexible object and operate the hand using relative velocities of the hand and the predetermined section of the flexible object. Consequently, the robot can perform work suitable for the flexible object.

### BRIEF DESCRIPTION OF THE DRAWINGS

The invention will be described with reference to the accompanying drawings, wherein like numbers reference like elements.

FIG. 1 is a diagram schematically showing an example of a state in which a robot system according to a first embodiment is used.

FIG. 2 is a diagram showing an example of the hardware configuration of a control device.

FIG. 3 is a diagram showing an example of the functional configuration of the control device.

FIG. 4 is a flowchart showing an example of a flow of processing in which a control section controls a robot to perform predetermined work.

FIG. 5 is a diagram illustrating a part of a picked-up image picked up by an image pickup section.

FIG. 6 is a diagram illustrating an end side of a flexible object detected from picked-up images by an end-side detecting section.

FIG. 7 is a schematic diagram for explaining processing for estimating shapes of a representative side of the flexible object and two sides at both ends of the representative side by a shape estimating section.

FIG. 8 is a diagram schematically showing an example of a state in which a robot system according to a second embodiment is used.

### DESCRIPTION OF EXEMPLARY EMBODIMENTS

### First Embodiment

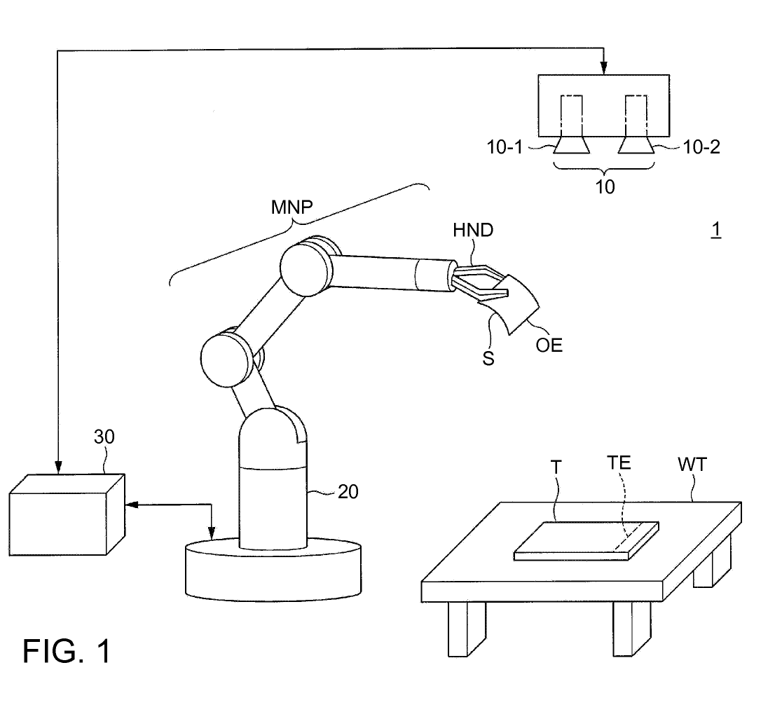

A first embodiment of the invention is explained below with reference to the drawings. FIG. 1 is a diagram schematically showing an example of a state in which a robot system 1 according to the first embodiment is used. The robot system 1 includes, for example, a first image pickup section 10-1, a second image pickup section 10-2, a robot 20, and a control device 30.

The robot system 1 arranges (sticks), using visual servo, a flexible object S gripped by the robot 20 in a target position of a target object T on a work bench WT on the basis of picked-up images picked up by the first image pickup section 10-1 and the second image pickup section 10-2. In this embodiment, the flexible object S is an object (an elastic object), the shape of which could change according to, for example, the influence of the movement of the robot, the gravity, and wind. For example, the flexible object S is a sheet-like object. The sheet-like object is, for example, a square label shown in FIG. 1. The material of the sheet-like object may be cloth, a metal foil, a film, a biological membrane, or the like. The shape of the sheet-like object may be another shape such as a circular shape or an elliptical shape instead of the square shape.

The work bench WT is a bench on which the robot 20 performs work such as a table or a floor surface. On the work bench WT, a target object T for arranging the flexible object S gripped by the robot 20 is set. As an example, the target object T is a tabular object shown in FIG. 1. However, the target object T may be any object as long as the object has a surface on which the flexible object S is arranged (stuck). A mark TE indicating a position where the robot 20 arranges the flexible object S is drawn on the surface of the target object T. Note that, on the surface of the target object T, the mark TE may be, for example, inscribed rather than being drawn. The mark TE does not have to be drawn on the surface of the target object T. However, in that case, the robot system 1 is configured to, for example, detect the contour of the target object T and recognize an arrangement position of the flexible object S.

The first image pickup section 10-1 is a camera including, for example, a first lens that condenses light, a CCD (Charge Coupled Device) or a CMOS (Complementary Metal Oxide Semiconductor) functioning as a first image pickup element that converts the light condensed by the first lens into an electric signal. The second image pickup section 10-2 is a camera including, for example, a second lens that condenses light and a CCD or a CMOS functioning as a second image pickup element that converts the light condenses by the second lens into an electric signal.

The first image pickup section 10-1 and the second image pickup section 10-2 function as an integrated stereo camera. In the following explanation, unless it is necessary to distinguish the first image pickup section 10-1 and the second image pickup section 10-2, the first image pickup section 10-1 and the second image pickup section 10-2 are referred to as image pickup section 10, which is the integrated stereo camera. In the following explanation, for convenience of explanation, the image pickup section 10 is configured to pick up a still image. However, the image pickup section 10 may be configured to pick up a moving image instead of the still image.

The image pickup section 10 is communicably connected to the control device 30 by, for example, a cable. Wired communication via the cable is performed according to a standard such as an Ethernet (registered trademark) or a USB (Universal Serial Bus). Note that the image pickup section and the control device 30 may be connected by radio communication performed according to a communication standard such as Wi-Fi (registered trademark).

The image pickup section 10 is set to pick up an image of a range including a movable range of a gripping section HND included in the robot 20, the flexible object S gripped by the gripping section HND, the surface of the target object T on the work bench WT. In the following explanation, for convenience of explanation, the range to be subjected to image pickup is referred to as image pickup range C. The image pickup section 10 acquires a request for image pickup from the control device 30 and picks up an image of the image pickup range C at timing when the request is acquired. The image pickup section 10 outputs the picked-up image to the control device 30 by communication.

The robot 20 is, for example, a single-arm six-axis vertical multi-joint robot. The robot 20 can perform an operation of six-axis degrees of freedom according to an associated operation of a support table, a manipulator MNP, the gripping section HND, and a not-shown plurality of actuators. Note that the robot 20 may operate in seven axes or more or may operate in five degrees of freedom or less. The robot 20 includes the gripping section HND. The gripping section HND of the robot 20 includes a claw section capable of gripping the flexible object S. The robot 20 is communicably connected to the control device 30 by, for example, a cable. Wired communication via the cable is performed according to a standard such as the Ethernet (registered trademark) or the USB. The gripping section HND is an example of a hand.

Note that the robot 20 and the control device 30 may be connected by radio communication performed according to a communication standard such as the Wi-Fi (registered trademark). The robot 20 acquires a control signal based on a three-dimensional position and a posture of the flexible object S from the control device 30 and applies predetermined work to the flexible object S on the basis of the acquired control signal. The predetermined work is work for, for example, moving the flexible object S gripped by the gripping section HND of the robot 20 from the present position and arranging the flexible object S in an arrangement position indicated by the mark TE on the target object T. More specifically, the predetermined work is work for, for example, arranging an end side facing a side of the flexible object S gripped by the gripping section HND to coincide with the mark TE on the target object T.

The control device 30 controls the robot 20 to perform the predetermined work. More specifically, the control device 30 derives a three-dimensional position and a posture of the flexible object S on the basis of a picked-up image including the flexible object S picked up by the image pickup section 10. The control device 30 generates a control signal based on the derived three-dimensional position and the derived posture of the flexible object S and outputs the generated control signal to the robot 20 to control the robot 20. The control device 30 controls the image pickup section 10 to pick up an image.

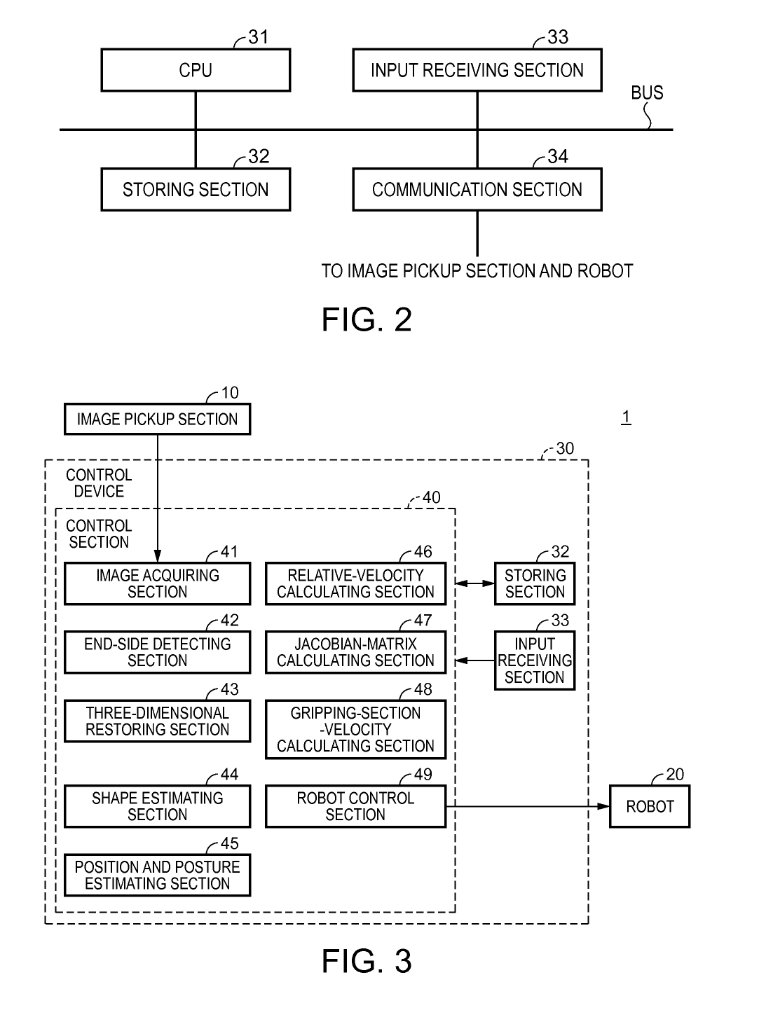

The hardware configuration of the control device 30 is explained with reference to FIG. 2. FIG. 2 is a diagram showing an example of the hardware configuration of the control device 30. The control device 30 includes, for example, a CPU (Central Processing Unit) 31, a storing section 32, an input receiving section 33, and a communication section 34. The control device 30 performs communication with the image pickup section 10, the robot 20, and the like via the communication section 34. These components are communicably connected one another via a bus Bus.

The CPU 31 executes various computer programs stored in the storing section 32. The storing section 32 includes, for example, a HDD (Hard Disk Drive), an SSD (Solid State Drive), an EEPROM (Electrically Erasable Programmable Read-Only Memory), a ROM (Read-Only Memory), or a RAM (Random Access Memory). The storing section 32 stores various kinds of information, images, and computer programs to be processed by the control device 30. Note that the storing section 32 may be an external storage device connected by, for example, a digital input/output port of the USB or the like instead of a storage device incorporated in the control device 30.

The input receiving section 33 is, for example, a keyboard, a mouse, a touch pad, or another input device. Note that the input receiving section 33 may be hardware integrated with a display section and may be configured as a touch panel.

The communication section 34 includes, for example, an Ethernet (registered trademark) port together with the digital input/output port of the USB or the like.

The functional configuration of the control device 30 is explained with reference to FIG. 3. FIG. 3 is a diagram showing an example of the functional configuration of the control device 30. The control device 30 includes a storing section 32, an input receiving section 33, and a control section 40. Among these functional sections, a part or all of the control section 40 is realized by, for example, the CPU 31 included in the control device 30 executing the various computer programs stored in the storing section 32. A part or all of the functional sections may be hardware functional sections such as an LSI (Large Scale Integration) and an ASIC (Application Specific Integrated Circuit).

The control section 40 includes an image acquiring section 41, an end-side detecting section 42, a three-dimensional restoring section 43, a shape estimating section 44, a position and posture estimating section 45, a relative-velocity calculating section 46, a Jacobian-matrix calculating section 47, a gripping-section-velocity calculating section 48, and a robot control section 49. The control section 40 causes the image pickup section 10 to pickup an image of the image pickup range C.

The image acquiring section 41 acquires the image picked up by the image pickup section 10.

The end-side detecting section 42 detects, on the basis of the picked-up image acquired by the image acquiring section 41, end sides of the flexible object S gripped by the gripping section HND. For example, when the flexible object S is a square label, the end sides of the flexible object S indicate remaining three end sides excluding the end side gripped by the gripping section HND among the four end sides of the square.

The three-dimensional restoring section 43 derives, on the basis of points (pixels) on the picked-up image representing the end sides of the flexible object S detected by the end-side detecting section 42, using epipolar constraint, three-dimensional coordinates in a world coordinate system of the points on the picked-up image representing the end sides of the flexible object S detected by the end-side detecting section 42.

The shape estimating section 44 estimates a shape of the flexible object S on the basis of the three-dimensional coordinates in the world coordinate system of the points on the picked-up image representing the end sides derived by the three-dimensional restoring section 43. More specifically, the shape estimating section 44 estimates a shape of the flexible object S on the basis of the three-dimensional coordinates by fitting, with a linear expression, the shape of an end side of the flexible object S, which is a side opposed to the end side gripped by the gripping section HND and fitting, with a quadratic expression representing a curved surface, the shapes of two end sides at both ends of the end side gripped by the gripping section HND.

In the following explanation, for convenience of explanation, the linear expression fit to the shape of the side opposed to the end side gripped by the gripping section HND is referred to as first approximation formula and the quadratic expression representing a curved surface fit to the shapes of the two end sides at both the ends of the end side gripped by the gripping section HND is referred to as second approximation formula. In the following expression, the end side fit by the first approximation formula is referred to as representative side of the flexible object S.

Note that, when fitting the shapes of the two sides at both the ends of the end side gripped by the gripping section HND, the shape estimating section 44 may be configured to fit the shapes with, for example, a cubit or higher-degree expression representing a curved surface or other expressions including a trigonometric function and an exponential function. The shape estimating section 44 generates a CG (Computer Graphics) of the flexible object S on the basis of the first approximation formula and the second approximation formula representing the shape of the flexible object S.

The position and posture estimating section 45 estimates (calculates) a position and a posture of a middle point of the representative side on the basis of the first approximation formula and the second approximation formula fit by the shape estimating section 44. In the following explanation, for convenience of explanation, unless it is necessary to distinguish the position and the posture of the middle point of the representative side, the position and the posture of the middle point of the representative side are referred to as position and posture of the flexible object S. The middle point of the representative side of the flexible object S is an example of the predetermined section of the flexible object.

The relative-velocity calculating section 46 detects, on the basis of the position and the posture of the flexible object S estimated by the position and posture estimating section 45, relative positions of a position set in the gripping section HND in advance and the middle point of the representative side of the flexible object S. The relative-velocity calculating section 46 calculates relative velocities on the basis of the detected relative positions.

The Jacobian-matrix calculating section 47 calculates a Jacobian matrix of the representative side of the flexible object S on the basis of the relative velocities calculated by the relative-velocity calculating section 46 and the CG of the flexible object S generated by the shape estimating section 44.

The gripping-section-velocity calculating section 48 calculates, on the basis of the Jacobian matrix calculated by the Jacobian-matrix calculating section 47, velocity for moving the gripping section HND that is gripping the flexible object S.

The robot control section 49 controls the robot 20 to move the gripping section HND on the basis of the velocity calculated by the gripping-section-velocity calculating section 48. The robot control section 49 determines on the basis of the picked-up image acquired by the image acquiring section 41 whether the robot 20 completes the predetermined work. When determining that the robot 20 completes the predetermined work, the robot control section 49 controls the robot 20 to change to a state of an initial position and ends the control of the robot 20.

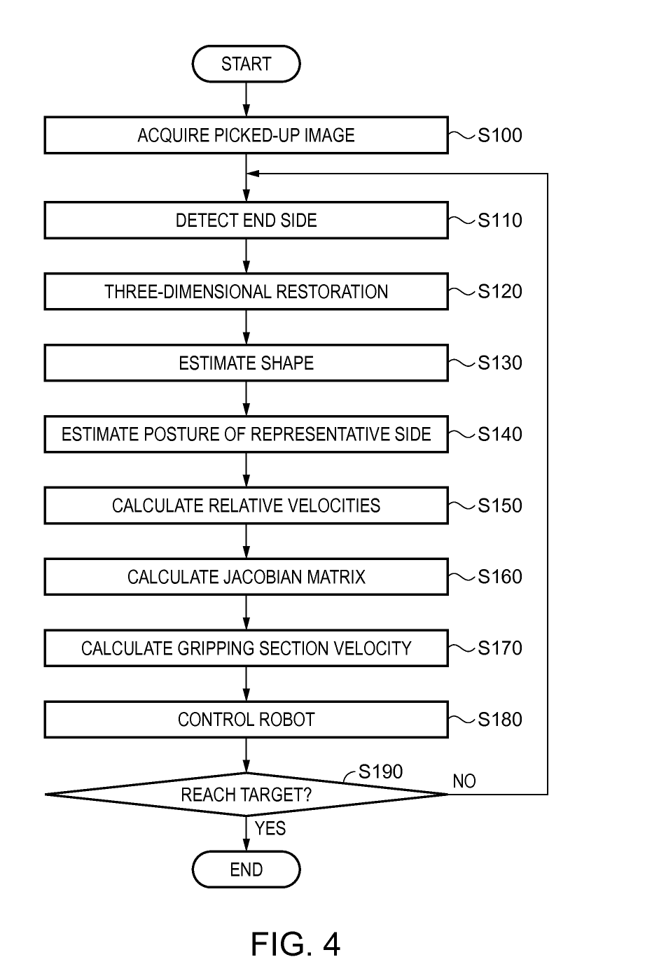

Processing in which the control section 40 controls the robot 20 to perform the predetermined work is explained with reference to FIG. 4. FIG. 4 is a flowchart for explaining an example of a flow of processing for controlling the robot 20. First, the control section 40 causes the image pickup section 10 pick up an image of the image pickup range C and acquires the picked-up image with the image acquiring section 41 (step S100).

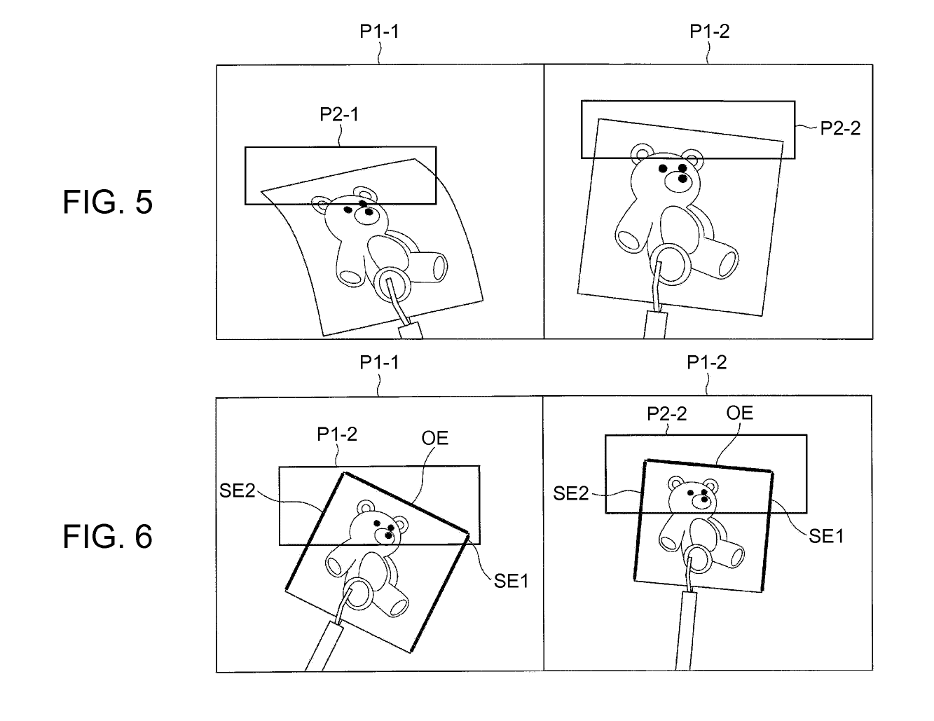

Subsequently, the end-side detecting section 42 detects the end sides of the flexible object S on the basis of the picked-up image acquired by the image acquiring section 41 (step S110). Processing in which the end-side detecting section 42 detects the end sides of the flexible object S is explained. FIG. 5 is a diagram illustrating a part of the picked-up image picked up by the image pickup section 10. A picked-up image P1-1 is a part of an image picked up by the first image pickup section 10-1. A picked-up image P1-2 is apart of an image picked up by the second image pickup section 10-2.

The end-side detecting section 42 sets a partial region in the picked-up image P1-1 and generates the set partial region as a picked-up image P2-1. In this case, the end-side detecting section 42 sets, from the picked-up image P1-1, a partial region of a predetermined size in a position corresponding to the position of the end side opposed to the end side gripped by the gripping section HND. Note that it is assumed that coordinates of points of the partial region set on the picked-up image P1-1 and coordinates of points on the picked-up image P2-1 are associated with each other when the picked-up image P2-1 is generated by the end-side detecting section 42. The end-side detecting section 42 may be configured to, for example, change the partial region of the predetermined size according to, for example, the length of the end side detected from the picked-up image P1-1 instead of setting the partial region of the predetermined size.

The end-side detecting section 42 sets a partial region on the picked-up image P1-2 and generates the set partial region as a picked-up image P2-2. In this case, the end-side detecting section 42 sets, from the picked-up image P1-2, a partial region of a predetermined size in a position corresponding to the position of the end side opposed to the end side gripped by the gripping section HND. Note that it is assumed that coordinates of points of the partial region set on the picked-up image P1-2 and coordinates of points on the picked-up image P2-2 are associated with each other when the picked-up image P2-2 is generated by the end-side detecting section 42. The end-side detecting section 42 may be configured to, for example, change the partial region of the predetermined size according to, for example, the length of the end side detected from the picked-up image P1-2 instead of setting the partial region of the predetermined size.

The end-side detecting section 42 detects end sides respectively from the picked-up image P2-1 and the picked-up image P2-2. In this case, the end-side detecting section 42 detects end sides from the picked-up images according to a CANNY method. Note that the end-side detecting section 42 may detect, rather than detecting an end side according to the CANNY method, an end side according to other publicly-known techniques for detecting an edge. The end-side detecting section 42 is configured to detect end sides from the picked-up image P2-1 and the picked-up image P2-2. This is because, since an image range in which image processing is performed is small, time of the image processing is reduced compared with when an end side is detected from the picked-up image P1-2 and the processing in step S110 and subsequent steps is performed. Therefore, the end-side detecting section 42 may be configured to detect end sides from the picked-up image P1-1 and the picked-up image P1-2 instead of detecting end sides from the picked-up image P2-1 and the picked-up image P2-2.

FIG. 6 is a diagram illustrating the end sides of the flexible object S detected from the picked-up image P1-2 and the picked-up image P2-2 by the end-side detecting section 42. Note that, in order to clarify a correspondence relation between the picked-up image P1-1 and the picked-up image P1-2 and a correspondence relation between the picked-up image P2-1 and the picked-up image P2-2, in FIG. 2, the picked-up image P1-1 is imaginarily shown in the back of the picked-up image P1-2 and the picked-up image P2-1 is imaginarily shown in the back of the picked-up image P2-2. In the picked-up image P1-2 and the picked-up image P2-2, an end side OE indicates the representative side of the flexible object S detected by the end-side detecting section 42. An end side SE1 and an end side SE2 respectively indicate two sides at both ends of the representative side detected by the end-side detecting section 42.

Subsequently, the three-dimensional restoring section 43 derives, on the basis of coordinates of points on the picked-up images representing the end sides (i.e., the end sides OE, the end side SE1, and the end side SE2) of the flexible object S detected from the picked-up image P1-2 and the picked-up image P2-2 by the end-side detecting section 42, using the epipolar constraint, three-dimensional coordinates in the world coordinate system of points on the picked-up images representing the end sides of the flexible object S detected by the end-side detecting section 42 (step S120). Subsequently, the shape estimating section 44 estimates, on the basis of the three-dimensional coordinates in the world coordinate system of the points on the picked-up images representing the end sides of the flexible object S derived by the three-dimensional restoring section 43, shapes of the end side OE, which is the representative side of the flexible object S, and the end side SE1 and the end side SE2, which are the two sides at both the ends of the representative side (step S130).

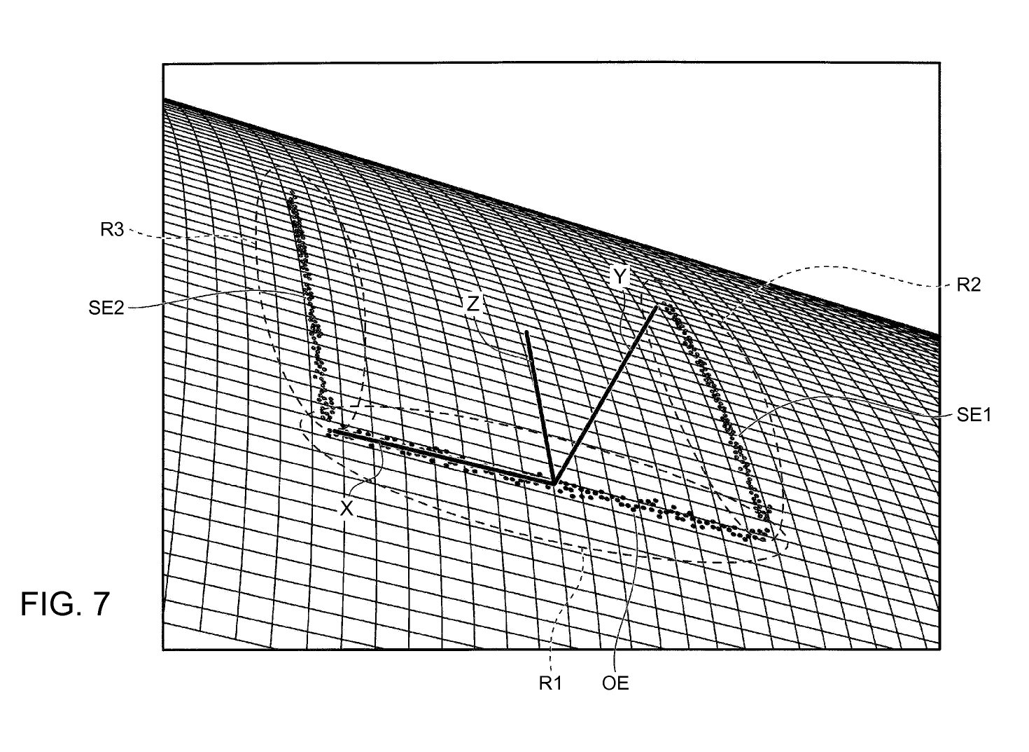

Processing for estimating shapes of the representative side of the flexible object S and the two sides at both the ends of the representative side by the shape estimating section 44 is explained with reference to FIG. 7. FIG. 7 is a schematic diagram for explaining the processing for estimating shapes of the representative side of the flexible object S and the two sides at both the ends of the representative side by the shape estimating section 44. In FIG. 7, points in a range surrounded by a dotted line R1 are obtained by plotting the three-dimensional coordinates in the world coordinate system of the points representing the representative side OE of the flexible objects derived by the three-dimensional restoring section 43. Points in a range surrounded by a dotted line R2 are obtained by plotting the three-dimensional coordinates in the world coordinate system of the points representing the end side SE1 of the flexible object S. Points in a range surrounded by a dotted line R3 are obtained by plotting the three-dimensional coordinates in the world coordinate system of the points representing the end side SE2 of the flexible object S.

The shape estimating section 44 estimates a shape of the representative side OE of the flexible object S by calculating a liner expression (an expression representing a straight line; the first approximation formula) to be fit to the points in the range of the dotted line R1 shown in FIG. 7. As indicated by Expression (1) shown below, the shape estimating section 44 estimates shapes of the end side SE1 and the end side SE2 of the flexible object S by calculating a quadratic expression (an expression representing a curved surface; the second approximation formula) that can simultaneously fit the points in the ranges of the dotted line R2 and the dotted line R3 shown in FIG. 7.

f(x,y)=a₀+a₁x+a₂xy+a₃y+a₄y² (1)

In the expression, a₀ to a₄ represent fitting parameters determined by fitting processing and x and y represent an x coordinate and a y coordinate of three-dimensional coordinates in the world coordinate system. After calculating the first approximation formula and the second approximation formula, the shape estimating section 44 generates a CG of the representative side on the basis of the first approximation formula and the second approximation formula.

Subsequently, the position and posture estimating section 45 calculates a position and a posture of the flexible object S (step S140). Processing for calculating a position and a posture of the flexible object S by the position and posture estimating section 45 is explained with reference to FIG. 7 again. The position and posture estimating section 45 calculates coordinates of intersections of a straight line represented by the first approximation formula representing the shape of the representative side and the end side SE1 and the end side SE2 represented by the second approximation formula and calculates a coordinate of a middle point of the representative side OE on the basis of the calculated coordinates of the intersections. In this embodiment, the position and posture estimating section 45 is configured to indicate the position of the flexible object S with the calculated coordinate of the middle point. However, instead, the position and posture estimating section 45 may be configured to indicate the position of the flexible object S with other positions such as the endpoint of the representative side and the center of gravity of the flexible object S. Note that, when indicating the position of the flexible object S with the center of gravity of the flexible object S, the position and posture estimating section 45 is configured to, for example, detect the shape of the flexible object S from the picked-up images and detect the center of gravity of the flexible object S on the basis of the detected shape.

The position and posture estimating section 45 sets a direction conforming to the first approximation formula as the direction of an x axis coordinate representing the posture of the representative side OE. The position and posture estimating section 45 calculates, by differentiating the second approximation formula, an expression representing a tangential line in the calculated position of the middle point of the representative side OE. The position and posture estimating section 45 sets a direction orthogonal to the calculated expression representing the tangential line (a normal direction at the middle point of the representative side OF) as a y-axis direction representing the posture of the representative side OE. The position and posture estimating section 45 calculates a z-axis direction from an outer product of unit vectors representing the x-axis direction and the y-axis direction. In this way, the position and posture estimating section 45 estimates a position and a posture of the middle point of the representative side of the flexible object S. Note that the position and posture estimating section 45 is configured to indicate the posture of the flexible object S with the directions of the coordinate axes set in this way. However, instead, the position and posture estimating section 45 may be configured to indicate the posture of the flexible object S with some other direction.

Subsequently, the relative-velocity calculating section 46 calculates, on the basis of the position and the posture of the flexible object S estimated by the position and posture estimating section 45, relative positions and relative postures of the position and the posture of the points (the positions) set in the gripping section HND set in advance and the position and the posture of the middle point of the representative side of the flexible object S. The relative-velocity calculating section 46 calculates, on the basis of the calculated relative positions and the calculated relative postures, relative velocities and relative angular velocities of the position set in the gripping section HND in advance and the middle point of the representative side of the soft object S from Expression (2) shown below (step S150).

$$( \begin{matrix}{\dot{r}}_{E}^{W} \\ {ω}_{E}^{W}\end{matrix} ) = ( \begin{matrix}I & {r}_{EH}^{W} \\ 0 & I\end{matrix} ) ( \begin{matrix}{\dot{r}}_{H}^{W} \\ {ω}_{H}^{W}\end{matrix} ) \qquad ( 2 )$$

In the expression, a suffix W affixed to r and ω indicates that r and ω are physical quantities in the world coordinate system. A suffix E affixed to r and ω indicates that r and ω are physical quantities concerning the middle point of the representative side of the flexible object S. A suffix H affixed to r and ω indicates that r and ω are physical quantities concerning positions set in the gripping section HND set in advance.

In the expression, r represents displacement. “•” represents time differential of a physical quantity represented by a character affixed with “•” (r affixed with “•” represents time differential of the displacement, that is, velocity). Note that the displacement of the flexible object S and the gripping section HND is calculated on the basis of, for example, positions of the flexible object S and the gripping section HND calculated in the initial position and positions of the flexible object and the gripping section HND calculated in the routine of this time. The position of the gripping section HND is calculated from forward kinetics.

In the expression, ω represents angular velocity. Angular velocity of the flexible object S is calculated on the basis of an initial posture or a posture of the flexible object S calculated in the last routine and a posture of the flexible object S calculated in the routine of this time. In the expression, I represents a unit matrix and r affixed with a suffix EH and a suffix W represents a translation matrix from the middle point of the representative side of the flexible object S to the position set in the gripping section HND in advance.

Subsequently, the Jacobian-matrix calculating section 47 calculates a Jacobian matrix of the flexible object S on the basis of the relative velocities calculated by the relative-velocity calculating section 46 (step S160). Processing for calculating a Jacobian matrix of the flexible object S by the Jacobian-matrix calculating section 47 is explained. The Jacobian-matrix calculating section 47 calculates a Jacobian matrix from Expression (3) below on the basis of the GC of the representative side of the flexible object S generated by the shape estimating section 44.

$$\begin{matrix}{J}_{img} = \frac{\partial s}{\partial {p}_{H}} \\ = \frac{\partial s}{\partial {p}_{E}} \frac{\partial {p}_{E}}{\partial {p}_{H}}\end{matrix} \qquad ( 3 )$$

In the expression, J affixed with a suffix img represents a Jacobian matrix, s represents a processed image in the routine of this time, and p represents a position and a posture. Subsequently, the gripping-section-velocity calculating section 48 calculates, on the basis of the Jacobian matrix calculated by the Jacobian-matrix calculating section 47, velocity for moving the gripping section HND that is gripping the flexible object S (step S170). Processing for calculating velocity for moving the gripping section HND, which is gripping the flexible object S, by the gripping-section-velocity calculating section 48 is explained. The gripping-section-velocity calculating section 48 calculates a pseudo inverse matrix of the Jacobian matrix and calculates velocity for moving the gripping section HND, which is gripping the flexible object S, from the calculated pseudo inverse matrix and Expression (4) below.

$${v}_{H} ( t ) = - λ {\frac{\partial {P}_{H}}{\partial {P}_{E }} [ \begin{matrix}α I \\ β \frac{\partial s}{\partial {P}_{E}}\end{matrix} ]}^{†} ( \begin{matrix}α ( s ( t ) - {s}^{*} ) \\ β ( {P}_{E} ( t ) - {P}_{E}^{*} )\end{matrix} ) \qquad ( 4 )$$

In the expression, V(t) affixed with a suffix H represents the velocity of the gripping section HND at time t. An upper component of a vector on the right side in Expression (4) is an expression for calculating velocity of the gripping section HND on the basis of a picked-up image. A lower component of the vector on the right side in Expression (4) is an expression for calculating velocity of the gripping section HND on the basis of the position and the posture of the middle point of the representative side of the flexible object S.

In the expression, a suffix “t” represents a pseudo inverse matrix, s(t) represents an image at time t, s affixed with a suffix * represents an image picked up when the flexible object S is arranged in a target position, λ represents a scalar gain and is a parameter for adjusting an output of the robot 20, p(t) affixed with a suffix E represents a position and a posture of the middle point of the representative side of the flexible object S at time t, and p affixed with the suffix E and the suffix * represents a position and a posture of the middle point of the representative side of the flexible object S that reaches a position where the flexible object S is stuck in the target object T.

In the expression, α and β are weights for determining whether speed for moving the gripping section HND is calculated on the basis of the picked-up image or speed for moving the gripping section HND is calculated on the basis of the position and the posture of the middle point of the representative side of the flexible object S. In this embodiment, as an example, α=(1−β), where α is a variable that takes a value in a range of 0 to 1 according to the distance between the flexible object S and the target object T on the basis of the picked-up image. The gripping-section-velocity calculating section 48 is configured to increase α as the flexible object S comes closer to the target object T. Instead, the gripping-section-velocity calculating section 48 may be configured to reduce α as the flexible object S comes closer to the target object Te. The gripping-section-velocity calculating section 48 may be configured to calculate velocity of the gripping section HND according to any one of the picked-up image and the position and the posture of the middle point of the representative side of the flexible object S (e.g., when α is always any one of 0 and 1).

Subsequently, when the robot 20 moves the gripping section HND, the robot control section 49 moves, on the basis of the velocity for moving the gripping section HND, which is gripping the flexible object S, calculated by the gripping-section-velocity calculating section 48 (step S180). Subsequently, the control section 40 causes the image pickup section 10 to pick up an image of an image pickup range, acquires the picked-up image, and determines, on the basis of the acquired picked-up image, whether the flexible object S can be arranged such that the representative side OE of the flexible object S coincides with the mark TE indicating the position where the flexible object S is stuck in the target object T (step S190). When determining that the flexible object S can be arranged (Yes in step S190), the control section 40 ends the processing. On the other hand, when determining that the flexible object S cannot be arranged (No in step S190), the control section 40 shifts to step S110 and performs processing of the next routine on the basis of the acquired picked-up image.

### Modification of the First Embodiment

A modification of the first embodiment is explained below. In the robot system 1 in the modification of the first embodiment, the image pickup section 10 is a light field camera. The light field camera is a camera in which micro lenses having different focal points are arrayed on a surface parallel to the surface of an image pickup element in front of the image pickup element. One light field camera is capable of performing stereo image pickup making use of an image including information in the depth direction obtained by such a configuration. Therefore, the control section 40 in the modification of the first embodiment performs the various kinds of processing explained in the first embodiment on the basis of a three-dimensional image stereoscopically picked up by the image pickup section 10, which is the light field camera.

Note that, in this embodiment, an example is explained in which the control device 30 controls the robot 20 using the visual servo. Not only this, but any other control method may be used as long as a picked-up image is used. For example, the control device 30 may be configured to control the robot 20 using pattern matching in which a picked-up image picked up by the image pickup section 10 is used.

As explained above, the robot system 1 according to the first embodiment causes the gripping section HND to operate using the relative velocities of the gripping section HND and the middle point of the representative side of the flexible object S. Consequently, the robot system 1 can perform work suitable for the flexible object S.

The robot system 1 grips the sheet-like object as the flexible object S and causes the gripping section HND to operate using the relative velocities of the gripping section HND and the predetermined section of the sheet-like object. Consequently, the robot system 1 can perform work suitable for the sheet-like object.

The robot system 1 causes the gripping section HND to operate using the relative velocities of the gripping section HND and the middle point of the representative side of the flexible object S. Consequently, the robot system 1 can perform work suitable for the flexible object S according to the movement of the representative side of the flexible object S.

The robot system 1 picks up an image including the flexible object S and calculates relative velocities of the basis of the picked-up image. Consequently, the robot system 1 can sequentially determine states of the gripping section HND and the flexible object S to move the gripping section HND and perform work suitable for the flexible object S.

The robot system 1 condenses, with the first lens, light including the flexible object S, which is made incident from a first direction, on the first image pickup element and condenses, with the second lens, light including the flexible object S, which is made incident from a second direction, on the second image pickup element. Consequently, the robot system 1 can calculate, on the basis of a first picked-up image picked up by the first image pickup element and a second picked-up image picked up by the second image pickup element, a three-dimensional position and a posture of the flexible object S by using the epipolar constraint. As a result, the robot system 1 can perform work suitable for the flexible object on the basis of the three-dimensional position and the posture of the flexible object.

The robot system 1 picks up an image including information in the depth direction obtained by the plurality of lenses. Consequently, the robot system 1 can calculate a three-dimensional position and a posture of the flexible object S on the basis of one picked-up image including information in the depth direction without using the epipolar constraint based on two picked-up images. Therefore, it is possible to reduce time of calculation processing.

The robot system 1 calculates, on the basis of the picked-up image, the first approximation formula and the second approximation formula representing the shapes of the representative side of the flexible object S and the two sides at both the ends of the representative side and calculates, on the basis of the calculated first approximation formula and the calculated second approximation formula, a position and a posture of the middle point of the representative side of the flexible object S. Consequently, the robot system 1 can perform work suitable for the flexible object S on the basis of changes in the position and the posture of the middle point of the representative side of the flexible object S.

The robot system 1 calculates a Jacobian matrix on the basis of the picked-up image and the relative velocities. Consequently, the robot system 1 can perform work suitable for the flexible object S on the basis of the Jacobian matrix.

The robot system 1 extracts a partial region including the representative side of the flexible object S in the picked-up image and calculates, on the basis of the extracted partial region, a first approximation formula and a second approximation formula representing a surface shape of the flexible object S. Consequently, the robot system 1 can reduce time of image processing compared with image processing performed on the basis of the entire picked-up image.

The robot system 1 calculates relative positions of the gripping section HND and the flexible object S on the basis of the position and the posture of the middle point of the representative side of the flexible object S and the position and the posture of the point set in the gripping section HND in advance to calculate the relative velocities. Consequently, the robot system 1 can perform work suitable for the flexible object S on the basis of the relative positions of the gripping section HND and the flexible object S.

The robot system 1 moves the gripping section HND with the visual servo on the basis of the Jacobian matrix. Consequently, the robot system 1 can perform work by the visual servo suitable for the flexible object S.

### Second Embodiment

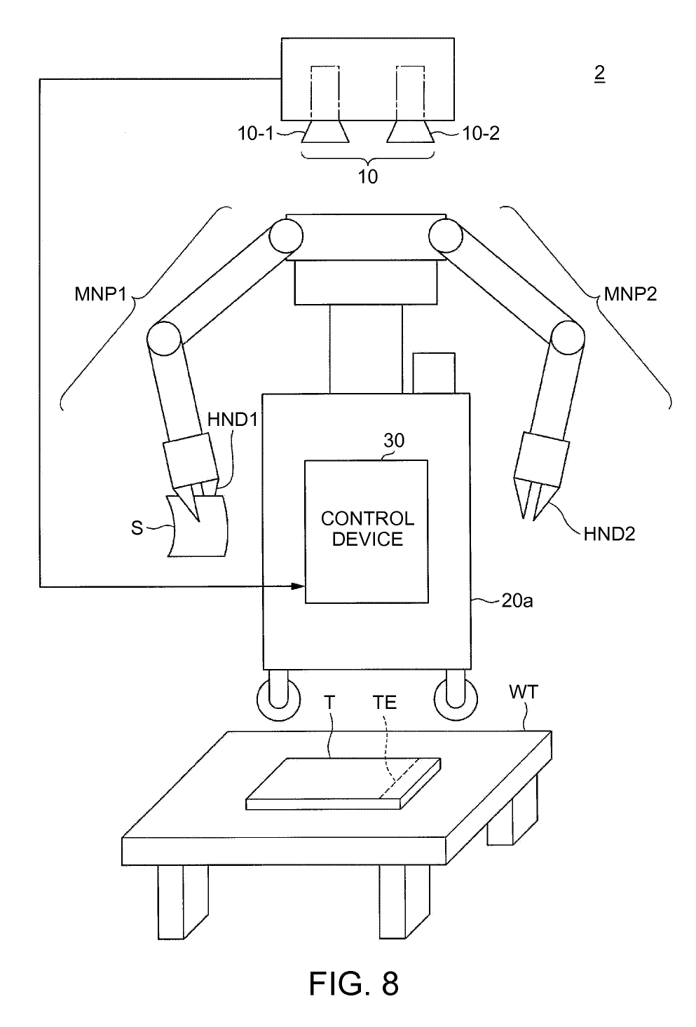

A second embodiment of the invention is explained below with reference to the drawings. FIG. 8 is a diagram schematically showing an example of a state in which a robot system 2 according to the second embodiment is used. The robot system 2 according to the second embodiment applies predetermined work to the flexible object S using a double-arm robot 20a instead of the single-arm robot 20. Note that, in the second embodiment, components same as the components in the first embodiment are denoted by the same reference numerals and signs. Explanation of the components is omitted.

The robot system 2 includes, for example, the image pickup section 10, a robot 20a, and the control device 30.

The robot 20a is a double-arm robot including, as shown in FIG. 8, in respective arms, for example, a gripping section HND1, a gripping section HND2, a manipulator section MNP1, a manipulator section MNP2, and a not-shown plurality of actuators.

The arms of the robot 20a are a six-axis vertical multi-joint type. One arm can perform an operation of six-axis degrees of freedom according to an associated operation of a support table, the manipulator section MNP1, and the gripping section HND1 by the actuators. The other arm can perform an operation of six axis degrees of freedom according to an associated operation of the support table, the manipulator section MNP2, and the gripping section HND2 by the actuators.

Note that the arms of the robot 20a may operate in five degrees of freedom (five axes) or less or may operate in seven degrees of freedom (seven axes) or more. The robot 20a performs, with the arm including the gripping section HND1 and the manipulator section MNP1, predetermined work same as the predetermined work of the robot 20 according to the first embodiment. However, the robot 20a may perform the predetermined work using the arm including the gripping section HND2 and the manipulator section MNP2 or may perform the predetermined work using both the arms. Note that the gripping section HND1 is an example of the gripping section. The gripping section HND1 of the robot 20a includes a claw section capable of gripping or pinching the flexible object S.

The robot 20a is communicably connected to the control device 30 by, for example, a cable. Wired communication via the cable is performed according to a standard such as the Ethernet (registered trademark) or the USB. Note that the robot 20a and the control device 30 may be connected by radio communication performed according to a communication standard such as the Wi-Fi (registered trademark).

As explained above, the robot system 2 according to the second embodiment performs, using the double-arm robot 20a, the predetermined work same as the predetermined work of the single-arm robot 20. Therefore, it is possible to obtain effects same as the effects in the first embodiment.

Note that a computer program for realizing the functions of any components in the robot systems 1 and 2 explained above may be recorded in a computer-readable recording medium and executed by causing a computer system to read the computer program. Note that the “computer system” includes an OS (Operating System) and hardware such as peripheral apparatuses.

The “computer-readable recording medium” refers to portable media such as a flexible disk, a magneto-optical disk, a ROM (Read Only Memory), and a CD (Compact Disk)-ROM and storage devices such as a hard disk incorporated in the computer system. Further, the “computer-readable recording medium” includes a medium that retains a computer program for a fixed time like a volatile memory (RAM: Random Access Memory) inside a computer system functioning as a server or a client when the computer program is transmitted via a network such as the Internet or a communication line such as a telephone line.

The computer program may be transmitted from a computer system, in which the computer program is stored in a storage device or the like, to another computer system via a transmission medium or by a transmission wave in the transmission medium. The “transmission medium” for transmitting the computer program refers to a medium having a function of transmitting information like a network (a communication network) such as the Internet or a communication line (a communication wire) such as a telephone line.

The computer program may be a computer program for realizing a part of the functions explained above. Further, the computer program may be a computer program that can be realized by a combination with a computer program, the functions of which are already recorded in the computer system, a so-called differential file (a differential program).

The entire disclosure of Japanese Patent Application No. 2014-051582, filed Mar. 14, 2014 is expressly incorporated by reference herein.

What is claimed is:

1. A robot comprising:
a hand configured to grip a flexible object; and
a control section configured to cause the hand to operate, wherein
the control section causes the hand to operate using relative velocities of the hand and a predetermined section of the flexible object.

2. The robot according to claim 1, wherein the flexible object is a sheet-like object.

3. The robot according to claim 1, wherein the predetermined section is a middle point of an end side of the flexible object.

4. The robot according to claim 1, further comprising an image pickup section configured to pickup an image including the flexible object, wherein
the control section calculates the relative velocities on the basis of the picked-up image.

5. The robot according to claim 4, wherein the image pickup section includes:
a first image pickup section including a first leans and a first image pickup element; and
a second image pickup section including a second lens and a second image pickup element, and
the image pickup section condenses, with the first lens, light including the flexible object, which is made incident from a first direction, on the first image pickup element and condenses, with the second lens, light including the flexible object, which is made incident from a second direction, on the second image pickup element.

6. The robot according to claim 4, wherein the image pickup section includes a plurality of lenses arrayed on a surface parallel to a surface of the image pickup element and having focal points different from one another and picks up an image including information in a depth direction obtained by the plurality of lenses.

7. The robot according to claim 4, wherein the control section calculates, on the basis of the picked-up image, an approximation formula representing a surface shape of the flexible object and calculates, on the basis of the calculated approximation formula, a position and a posture of the predetermined section of the flexible object to calculate the relative velocities.

8. The robot according to claim 7, wherein the control section extracts a partial region including the predetermined section of the flexible object in the picked-up image and calculates, on the basis of the extracted partial region, an approximation formula representing a surface shape of the flexible object.

9. The robot according to claim 7, wherein the control section calculates relative positions of the hand and the flexible object on the basis of the position and the posture of the predetermined section of the flexible object and a position and a posture of a point set in the hand in advance to calculate the relative velocities.

10. The robot according to claim 7, wherein the control section calculates a Jacobian matrix on the basis of the picked-up image and the relative velocities.

11. The robot according to claim 10, wherein the control section moves the hand using visual servo on the basis of the Jacobian matrix.

12. A robot system comprising:
an image pickup section configured to pick up an image including a flexible object;
a robot including a hand that grips the flexible object; and
a control section configured to cause the hand to operate, wherein
the control section causes the hand to operate using relative velocities of the hand and a predetermined section of the flexible object.

13. A control device that causes a robot to operate, the robot including a hand that grips a flexible object, wherein
the control device causes the hand to operate using relative velocities of the hand and a predetermined section of the flexible object.
